(19) United States
(12) Patent Application Publication
(10) Pub. No.: US 2009/0119158 A1
(43) Pub. Date: May 7, 2009

(54) METHOD AND DEVICE FOR TRACING AND LOCATING WEB SERVICES CHANGES DURING UPDATING PROCESS

(75) Inventors: Ying Chen, Beijing (CN); Ru Fang, Beijing (CN); Li Wang, Beijing (CN)

Correspondence Address: Anne Vachon Dougherty, 3173 Cedar Road, Yorktown Hts., NY, 10598, US

(73) Assignee: International Business Machines Corporation, Armonk, NY (US)

(21) Appl. No.: 12/260,968

(22) Filed: Oct. 29, 2008

(30) Foreign Application Priority Data
Oct. 31, 2007 (CN) 200710168209.9

(51) Int. Cl. G06Q 10/00; G06F 17/30; G06F 17/40; G06Q 50/00

(52) U.S. Cl. 705/10; 707/102; 707/E17.005; 707/E17.112

(57) ABSTRACT

A method and device for tracing and locating web service changes during client web service application updating process. The method and device of the present invention could be implemented in a client application development platform of the web service, or in a server of the web service provider, or in a third party independent of the web service user and provider. The present invention locally customizes release notes or online API update guides for each user. A change history of a target web service concerned by user could be locally traced and locally stored, thus users can easily use said change history to update its codes locally.

### TECHNICAL FIELD

The present invention relates to client applications of web services, especially to the method and device for tracing and locating web services changes during updating client web application process.

### TECHNICAL BACKGROUND

Booming of web services makes more people depend on web-service based software to do their business. For instance, there are a lot of service suppliers providing web services (also called as online API) for users, such as Map service from Google*, picture service from Flickr*, video service from YouTube*. ProgrammableWeb* (at programmableweb.com) has listed current popular Web services. Users can build their own applications by using or integrating these Web services expediently. For example, users are able to use eCommerce Web service provided by eBay and Map service from Google to build a convenience application to search for product's price and suppliers' location. *May be a trademark of the respective company

But these online APIs (application interface) change frequently, periodically or non-periodically. These frequently-changed web services raise a big challenge for users, namely, how to easily notify the users of these changes and adapt to these changes in a highly efficient way.

For example, considering the Web service provided by eBay*, in April 2004 there are:
More than 200,000 eBay sellers use the applications based on eBay Web service;
eBay sellers using API-enabled software applications generate (on average) 595 new listings and $10,202 in GMS per minute on eBay;
40% percent of the product listing and search service function is facilitated through eBay Web Services;
eBay supports more than 1 billion API calls per month.
   The above data comes from White Book of O'Reilly, Web Services in Action: Integrating with the eBay® Marketplace (see: cascadetg.com at page ebaywebservices.pdf)

These numbers have increased rapidly in recent years. According to further observation and analysis of the Web service provided by eBay, it has been found that:
Two regular release notes are scheduled to be published every month, indicating the changed calls, schema changes, new features, etc.;
Schema changes happen in most release notes;
One proficient developer may need to spend 2 days to adjust his code to adapt the new release service.

So a big problem coming along in such context is how to help developers track the changes of the target Web services easily and modify their code efficiently.

Currently when the service providers publish the new version of Web services, the new services are versioned by the version numbers or the timestamps. At the same time, release notes or online API update guides are also delivered to help the developers to change their client codes. Most release notes are html pages and published to the service consumers in RSS/Atom feeds or emails. For instance, eBay Web service version (refer to developer.ebay.com) are organized by their own version numbers and are sent to the developers once the new version is published. Amazon Web service are managed by mangling the timestamps to the namespace to mark the service version, the developers can be notified by email or by subscribing the release note page's RSS feeds.

However, the drawbacks of the currently known methods are listed as follows:
Service providers publish the release notes according to their own contents and format. But the release notes cannot be customized. So each service requester needs to read the whole release note then can they know if it includes their change of application and if they need to change their client applications.
Commonly the release notes are too long and the size of the client applications may be huge. So it's hard for the developers to find which part of the release notes they need to consider and which part of the code they need to adjust in order to adapt the target service changes.
The release notes are published frequently and regularly (e.g., every two weeks), but the developers may not read them and update the application on time each time for certain reasons, such as on a business trip and etc. For example, when the developers are back from a business trip several months later, they find out that they have to manually deal with a lot of release notes. This is a big job and very easy to make mistakes.

Further descriptions are made as follows. Firstly, as shown in FIG. 1a, the service provider sends a release note 1, the user identifies related portions based on the application of their own, namely, element A changes to element A1, element B changes to element B1, element C changes to element C1. Secondly, the user revises corresponding codes based on these changes, but sometimes, the user may miss some changes for some reasons, for example, this change of this time is not very important and will not affect the usage of the application. So the user may forget about this change. And then the problem comes. Let's assume the user omits the first change, namely he forgets to change element A to A1. Now the service provider sends Release Note 2 as shown in FIG. 1b, element A1 changes to element A2, element B1 changes to element B2, element C1 changes to element C2. Obviously, it is very difficult for the developers to realize that the old element A in the client code has been changed to A2, because he has forgotten that element A is changed to element A1 at the first time, so there is no A1 in his application. Unfortunately, he will lose all changes of element A in future and this may cause the application couldn't work. When this happens, it is extremely difficult for the user to find out the location of the problem.

### SUMMARY OF THE INVENTION

To solve the above-mentioned problem, the present invention provides a novel method and device for tracing and locating web service changes involving the client's application so that it is more convenient to change the client's application.

To achieve this, the present invention has designed a method and device not only help users record related changes of web services dynamically and efficiently without too much human efforts, but also automatically locate which part of the application shall be changed and the corresponding change history.

The present invention uniquely provides a method and device for tracing and locating web service changes to keep a change history of a target web service at the side of Web service clients. The method and device of the present invention could be implemented as a plug-in or library that may be added into the development platform of Web service client application. Alternately, the method and device of the present invention can be added into the server of web service provider, or be provided to a third party independent of said web service user or provider.

The advantage of the present invention include at least one of the followings: The release notes or the online API update guides can be customized for each consumer locally; the change history of the target web service concerned by the user can be tracked and stored locally; the present invention also can transform all changes into standard primitive descriptions, thereby unifying various service change descriptions from all kinds of web service providers and eliminating the differences between different web providers. Users can easily use the above-mentioned change history to locally update client codes, which is the basis of auto-update of client codes.

In one aspect, the present invention provides a change history recording method for recording web service change history, including a receiving step of receiving release notes of web service change description; a transforming step of finding out change descriptions corresponding to Customer Used Elements from the release notes; a history generating and storing step of generating a change history for said Customer Used Elements on the basis of said change descriptions corresponding to said Customer Used Elements and locally storing it at the client side.

In the other aspect, the present invention provides a change history recording device for recording web service change history, including: a transformation engine used for receiving release notes of web service change description, and finding out change descriptions corresponding to Customer Used Element from the release notes; history generating means, used for receiving change description of said Customer Used Elements from the transformation engine, and generating a change history of said Customer Used Elements.

In a further aspect, the present invention provides an embodiment for a change-update supporter, which updates client application according to release notes, the above mentioned change-update supporter includes: the change history recording device as described above; a release note receiving means used for receiving new release notes and inputting them into the change history recording device, said release note including change descriptions of web services; a code searching means used for searching Customer Used Elements from the client application and input them into the change history recording device, and wherein the change history recording device outputs a change history of said Customer Used Elements.

### BRIEF DESCRIPTION OF THE DRAWINGS

Hereinafter an exemplary method and device will be described with references to the following descriptions and figures. Considering the following detailed description and figures, other advantages and novel characteristic are obvious. The inventive concept itself as well as a preferred embodiment will be best understood by referring to the following detailed description of embodiments and drawings, wherein:

FIG. 1a and 1b show samples of release notes published in the prior art.

FIG. 2 shows one preferred embodiment of the change history recording method of the present invention.

FIG. 3 shows the change history recording method and device of the present invention are implemented in client development platform of web services.

FIG. 4 shows blocks of the change history recording device of a preferred embodiment of the present invention.

FIG. 5 shows the details of the change history recording device showed in FIG. 4.

FIG. 6-7 shows how to use the present invention to solve the technical problem raised in the technical background of this invention.

FIG. 8 shows an example that applies the present invention to Amazon E-Commerce Web service.

FIG. 9 shows an example that the change history recording device of the present invention is implemented in web service provider.

### PREFERRED EMBODIMENTS

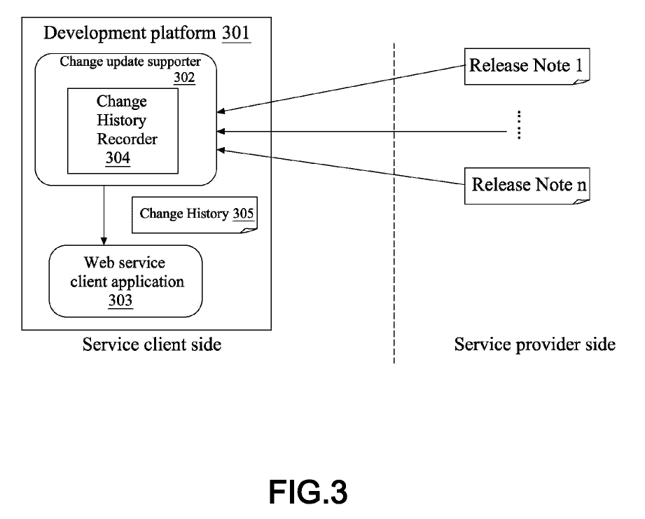

With reference to FIG. 2, it shows one preferred embodiment of change history recording method of the present invention. The method is used to record the web service change history, including: a receiving step 201, used for receiving release notes, wherein the release notes include change description of web services; a transformation step 202, used for transforming the release notes based on predefined transformation rules, and finding out change descriptions in relation to Customer Used Elements from the transformed release note, and generating a customized release note, wherein the Customer Used Elements include at least one of the web service, operation, message, data element, type, attribute etc. used in the client application or any combination thereof, a history generating step 203, used for generating a change history of the Customer Used Elements based on the change descriptions in relation to the Customer Used Elements and locally storing the change history.

According to one preferred embodiment of the present invention, the above-mentioned transformation rules involves how to transform various kinds of release notes into standard change description primitives. For example, one preferred group of standard change description primitives of the present invention is: “ADD”, “REMOVE” and “UPDATE”, it will be more detailed in the following text.

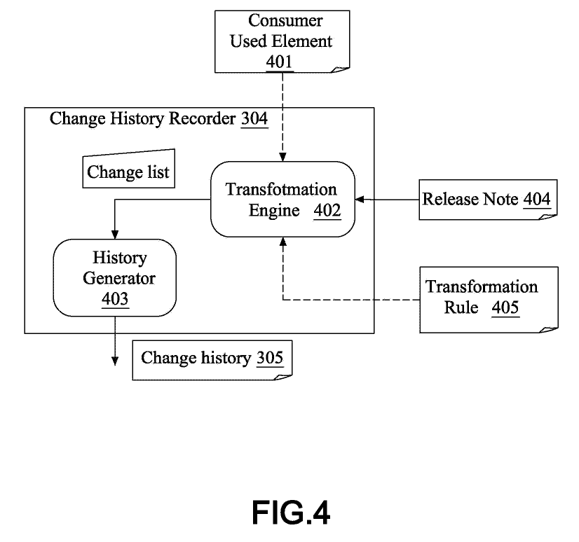

With reference to FIG. 3, it shows a preferred embodiment of the device implementing the change history recording method. In this embodiment, the change history recording device 304 is implemented at the client side. Specifically, it is implemented in client development platform 301 of the current web service. The change history recording device 304 could be implemented as being resided in the change update supporter 302 of the client side. The change history recording device 304 can maintain the change history 305 of the used service elements of this web service client application 303. Base on the change history recording device 304, the change update supporter 302 can help user update the client application 303 according to new release notes. Then developers at the client side can easily find out which part of their client codes is to be changed.

As those skilled in the art can understand, given the change history recording device 304 proposed by the present invention, change update supporter 305 can provide great assistance to clients, such as prompting users the updating of client applications according to the change history recorded by the change history recording device 304, even updating codes automatically according to the change history. The following text will make further introduction about these expanded functions provided by the change history recording device of the invention.

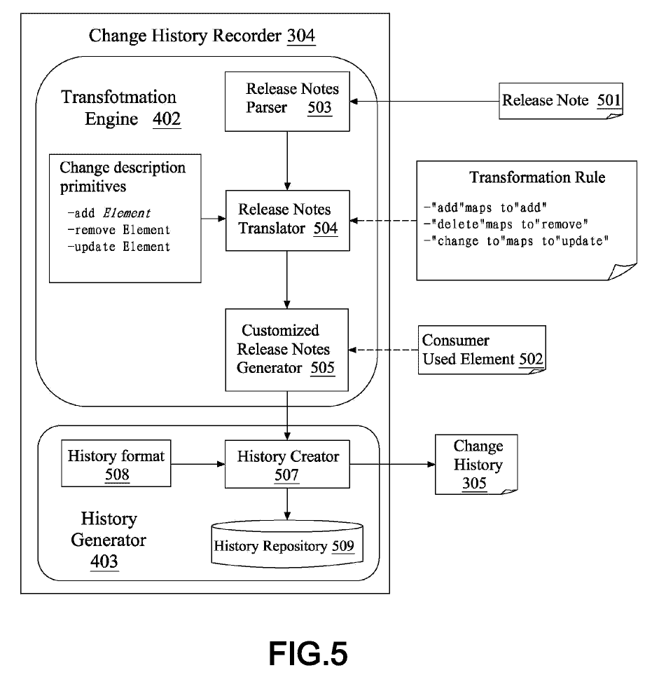

With reference to FIG. 4, it shows a block diagram of change history recording device 304 as one embodiment of the present invention.

The change history recording device 304 includes two parts, transformation engine 402 and history generator 403.

In one aspect, transformation engine 402 receives a new release note from the web service provider, and transforms it into a predetermined format. As those skilled in the art can understand, it is possible to use the prior art to receive release notes, such as email, RSS feeder, Atom receiver, FTP and etc.

On the other aspect, transformation engine 402 receives “Consumer Used Elements” 401, wherein “Consumer Used Elements” 401 usually include the used services, operations, messages, elements, types, attributes, etc. when user develops applications. customer Used Element 401 can be manually input by developers. Alternatively, it can be obtained through prior art means, such as code searching and text matching. For instance, at present, each web service provider provides WSDL files (e.g., WSDL files of Amazon Web can be downloaded from the website webservices.amazon.com at AWSECommerceService.wsdl?), which gives the detailed descriptions of the original web service. Since WSDL is an Extensible Markup Language, all the element names of this web service can be obtained by using various existing XML parsers or WSDL parsers to parse the WSDL files of the original web service. There are a lot of available WSDL parsers, such as WSDL4J[3], C++WSDL Parser[4] and etc. Then, after developers develop the client applications, a simple code reader could be used to compare the used elements in the client application with all web service element names obtained from WSDL files and to find out the names of customer used elements.

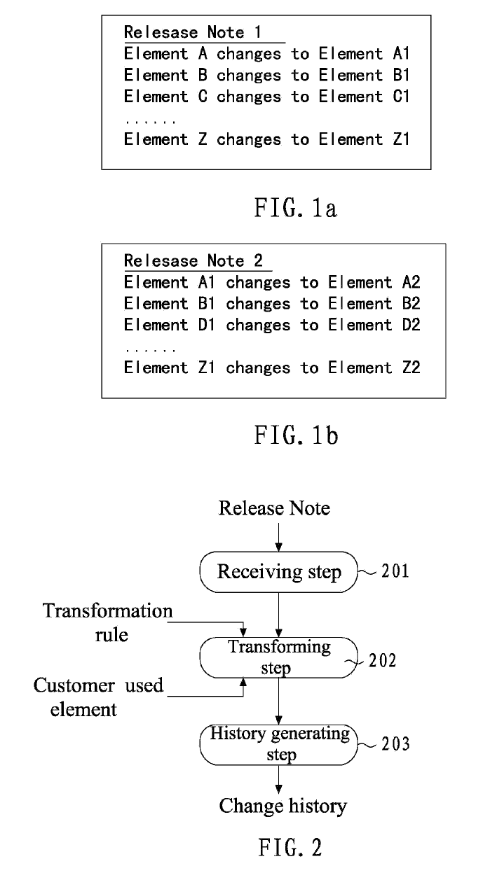

After receiving customer used element 401 and the new release note 404, transformation engine 402 will search the new release note 404 to find out change descriptions in relation to customer used elements 401, e.g., “Element A changes to element A1” as shown in FIG. 1a is a change description in relation to A, and to transform this part of change description on the basis of certain transformation rules, and then send it to history generator 403.

The history generator receives the change description in relation to the customer used elements from transformation engine 402, and records this change description as change history 305 according to a predetermined history format, and stores the change history 305 locally or remotely.

As those skilled in the art can understand, the change history can be used to help developers modify their application codes. This can be achieved through the static or dynamic auto-update of programs, or through notifying users to modify the code manually.

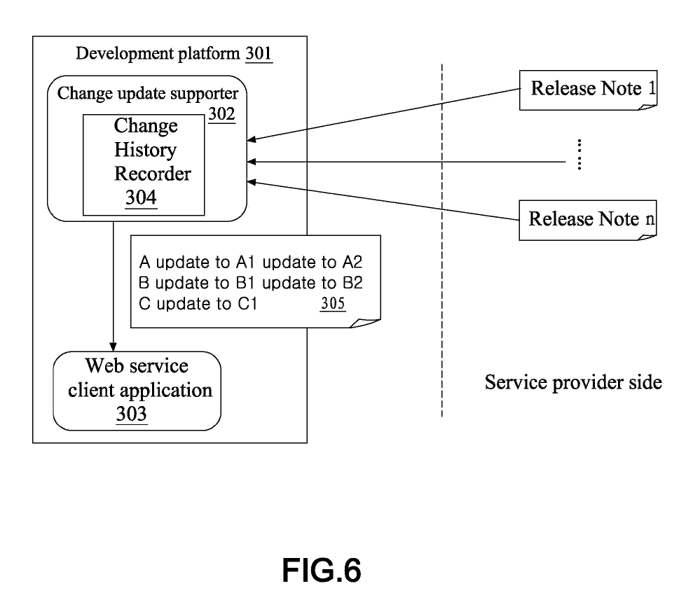

With reference to FIG. 5, it shows a preferred structure of change history recording device of the present invention. It should be understood that the embodiment in FIG. 5 is only an illustrative description rather than a restrictive description. Those skilled in the art can realize the specific structure of the change history recording device of the present invention may be implemented in various ways based on the teachings of FIG. 4.

Transformation engine 402 in the change history recording device 304 includes 3 components to support the transformation: release note parser 503, release note translator 504, and customized release generator 505.

The operation of release note parser 503 is to parse the release note 501 and obtain the descriptions of web service changes. At present, different web service providers provide different formats of release notes, for example, Google, eBay, Amazon and other web service providers provide release notes in their own formats. XML parsing technique (such as DOM, SAX that can be used to read RSS files or Atom files), for example, could be used to parse it, and transform it into desired formats.

In addition, since different web service providers usually provide release notes in different change description primitives, it is necessary to map them into one unified change description primitive.

One preferred embodiment of the present invention adopts 3 change description primitives 506: ADD, REMOVE and UPDATE, to uniformly translate the received release notes. ADD primitive indicates a new service element (including service, operation, message and etc.) is added into the target service. REMOVE primitive indicates a service element is removed from the target service. UPDATE primitive indicates a service element in the target service is renamed or its value is changed. All changes can be described by one of the above 3 standard primitives.

Accordingly, predefined transformation rules could be as follows:
“ADDED”, “NEW” being mapped to “ADD”;
“DELETE”, “CANCEL”, “REMOVE” being mapped to “REMOVE”;
“CHANGE TO”, “CHANGED TO” being mapped to “UPDATE”.

After release note translator 504 receives the parsed release note, the parsed release note is translated and transformed according to the above transformation rules, the resulting contents are defined by uniform change description primitives.

As those skilled in the art can understand, the above transformation rules are just an illustration. Transformation rules can be provided by the web service providers or developers of the client application, mapping between change description primitives of release notes and the change description primitive predefined by users.

Change description primitives of various kinds of release notes are translated and transformed uniformly, such as “CHANGE TO” and “CHANGED TO” are both translated into “UPDATE” primitive. After such processing, all changes described in release notes are described using the three standard primitives. One advantage is to unify service change descriptions of various web service providers at the client side, and to eliminate the differences among different web service providers; another advantage is to provide support for subsequent updating of client application, and subsequent applications can recognize changes in terms of description primitives so as to help user update the application.

Then, Customized Release Note Generator 505 will choose those change descriptions concerned by the client application developer according to a list of customer used elements.

As mentioned above, the list of customer used elements 502 describes which service elements are already used by the client application, it can be manually input by developers or automatically obtained through prior art means, such as code searching and text marching. On the basis of the list of customer used elements 502, Customized Release Note Generator 505 finds out the changes in relation to customer used elements, generates a customized change description, and sends it to history generator 403.

As shown in FIG. 5, according to a preferred embodiment of the present invention, history generator 403 includes History Creator 507 and History Repository 509.

History Repository 509 stores change history files for every service used by the client application. For example, the client application uses two services, one is Amazon E-commerce web service, and the other is Google Map web service. Then, the client can use two change history files to maintain change histories for the two services. History Repository 509 can store these two files. Said change history could be a database, a file system or even a document file. For instance, if the change repository is implemented as a database, the change history file will be parsed, and contents of the file will be stored as items in the database. If History Repository 509 is implemented as a file system, the change history will be written into a file and be directly stored in the file system.

Web service client developer can access the History Repository 509 to obtain the change history.

History Creator 507 is used to create a new change history record. For example, History Repository 509 obtains the created change history record, inserts the new change descriptions into the change history record according to a predefined history description format 50, and generates a new change history record. As those skilled in the art can understand, History Description Format 508 can be defined on demand by the client application developer or the client side of the service.

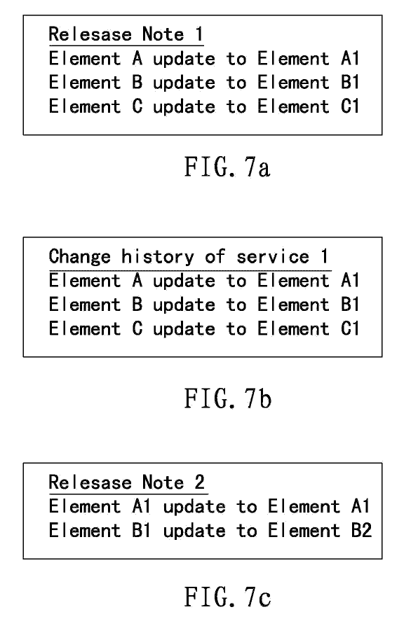

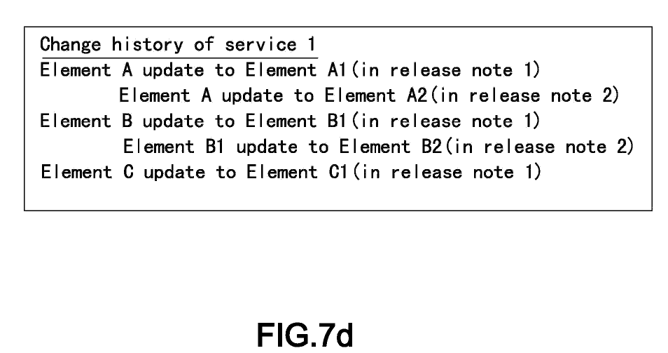

With reference to FIGS. 6-7, it shows an example of how the present invention overcomes the technical problem raised in the technical background. The system of FIG. 6 is largely identical with that of FIG. 3. Considering the example mentioned in the technical background, the received release notes 1 to n could be the release note 1 and release note 2 in FIGS. 1a and 1b. When the release note 1 arrives, it is transformed based on transformation rules, and changes in relation to the client application are selected.

It is assumed that the client application only uses service elements A, B and C. The currently used elements are updated to A1, B1 and C1.

After some time, the release note 2 arrives. As shown in FIG. 7c, the release note 2 is customized so as to maintain change descriptions in relation to the used elements A1, B1 and C1 only. In release note 2, element A1 is renamed to A2, B1 is renamed to B2.

Then, the change history in relation to used elements A, B and C is for example a tree data structure as shown in FIG. 7d. In this embodiment, the History Description Format only uses terms “to” and “in . . . ” to keep a change-chain in release notes.

Here, if the developer wants to update his client codes, it is quite easy to find out which part of the source code needs to be changed and which part of the release note needs to be referred, with reference to FIG. 7d.

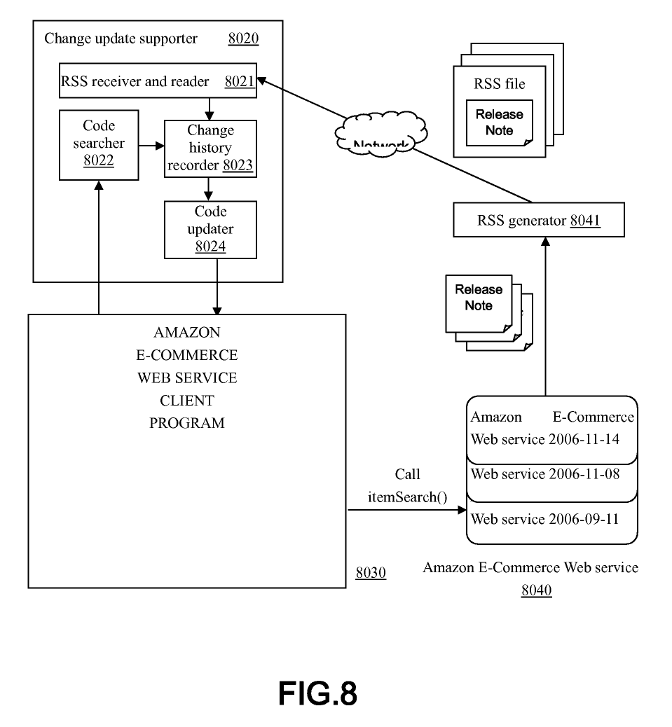

With the reference to FIG. 8, Amazon E-Commerce Web service and Eclipse development platform are used to show an illustration of the processing of “change history recording device” of the present invention. Please note that in this embodiment, the change history recording device is implemented in the client application development platform, which is Eclipse development platform.

The function performed by the client application 8030 is: based on the user input, call itemSearch( ) of Amazon e-commerce web service 8040 to search products and print out all product attributes.

Amazon publishes its own release note though RSS. As those skilled in the art can understand, RSS Receiver and Reader 8021 can receive these release notes. In this embodiment, code searching method is used to find out all Amazon e-commerce Web service elements used by the client. In this embodiment, the used web service 8040 is “itemSearch( )” method. According to the wsdl file released by Amazon, the input and output messages of “itemSearch( )” are defined as “ItemSearchRequest”, “ItemSearchResponse”; data elements of the messages are “ItemAttributes”, etc. The details of said method “Itemsearch”, message “Itemsearchrequest”, “Itemsearchresponse” and data element “ItemAttributes” are defined in a wsdl file (with reference to webservices.amazon.com at AWSECommerceService.wsdl?)

As those skilled in the art can understand, the logical level of the above “method”, “message” and “data element” are simplified from high to low as follows:

Itemsearch

Itemsearchrequest
Itemsearchresponse

ItemAttributes

......

In this embodiment, by means of code searcher 8022, service elements being used by current user application can be detected, such as “Itemsearch” method; “Itemsearchrequest” and “Itemsearchresponse” messages; “ItemAttributes” data element and etc. However, in this field, method (such as “Itemsearch”) and message (such as “Itemsearchrequest” and “Itemsearchresponse”) are usually not selected as customer used elements. This is because release notes rarely include changes of “method” and “message”. The most frequent changes of release notes occur under the message level, such as changes in data element level of “ItemAttributes” or even lower level “attribute”. Therefore, “ItemAttributes” is selected as a customer used element in this example.

It shall be noted that, since “ItemAttributes” is chosen as a customer used element, certain changes (such as changes of adding a new “method” or new “message”) cannot be detected in the present embodiment. However, since the existed client application cannot use a new method, the change of adding a new method is not concerned by users of the client application. In addition, regarding a “method” provided by web service, input and/or output messages are usually fixed, the actual release note will not add any new message. In addition, there will substantially be no changes of updating “method” or “message” in release notes, because specific changes actually occur at and belong to a level lower than “message”.

In this example, after related change history is generated base on the client used element “ItemAttributes”, code updating is mainly manually performed. The function of Code Updater 8024 is to reflect related changes in the editing window of eclipse.

The release note of Amazon E-Commerce Service 8040 refers to the page connect/kbcategory.jspa at amazonwebservices.com.

As shown in FIG. 8, Amazon released 3 release notes in 3 months, dated as 2006-9-11, 2006-11-8, 2006-11-14. The release website can be found on amazonwebservices.com at entry.jspa?externalID=421&categoryID=17 as well as external ID=480&categoryID=17 as well as externalID=493&categoryID=17.

As shown in FIG. 8, the above 3 release notes are sequentially sent through RSS Generator 8041, and input into RSS Receiver and Reader 8021, and then input into the change history recording device 8023 of the present invention. In the change history recording device 8023, the above release notes are transformed into standard change description primitives according to predefined transformation rules.

Regarding the Amazon E-commerce Web service release notes, the predefined transformation rules are defined as follows:
“New features” corresponds to “add”
“Resolved issues” corresponds to “update”.
   Please note that in the above Amazon release notes there is no change of “remove” being detected, so it is not necessary to have transformation rule of “remove”.

At the meantime, code searching is performed on the client application. As mentioned above, in this embodiment, which service element is used in the client application is found out through said service element searching part (i.e., Code Searcher). The results could include: “Itemsearch” method; “Itemsearchrequest” and “Itemsearchresponse” messages; “ItemAttributes” data element and etc. In this embodiment, “ItemAttributes” is selected as a customer used element. Please note this is only for illustration, rather than restriction.

After confirming the customer used elements is “ItemAttributes”, “ItemAttributes” is used as a keyword to search the release notes. For each release note and each customer used element, it performs a thoroughly searching using the keyword to find corresponding descriptions, and then records any code portion containing this keyword or even a table line containing this keyword, and stores it in a change history of this keyword.

For example, the customer used element is “ItemAttributes”, when a release note arrives (such as the release notes of 2006-9-11, 2006-11-8 and 2006-11-14), a thorough search is done using “ItemAttributes” as keyword, and records any description portion or table lines containing said keyword “ItemAttributes”, and stores them in the change history of this keyword, so as to obtain the customized change history record of the customer used element “ItemAttributes”.

The final resulted change history record can be stored in the change history recording device 8023 as a HTML file, for example. According to a preferred embodiment, the contents of said file are as follow:

Change History of Amazon E-commerce Web Service

Element ItemAttributes
Add attributes (in release note 2006-09-11):
   AnalogVideoFormat—Video format
   ClubType—Type of golf club
   CompatibleDevices—Compatible devices
   DataLinkProtocol—Datalink protocol
   DisplayColorSupport—Color depth supported by the display
   FilmColorType—Type of film
   FormFactor—External memory type
   Genre—Specifies the genre of the item
   HandOrientation—Specifies whether the golf club is for people who are right handed or left handed
   HardDisklnterface—Specifies the hard drive interface, such as SCSI
   HardwarePlatform—Specifies the computer hardware platform
   LensType—Type of camera lens
   MediaType—Type of storage media
   OperatingSystem—Computer's operating system
   OpticalSensorResolution—Resolution of optical sensors
   ProductTypeName—Name of the product type
   ProductTypeSubcategory—Subcategory of the product type
   RemovableStorage—Type of removable storage media. See MediaType
   RequiredVoltageRange—Maximum voltage allowed.
   SkillLevel—Specifies the skill level recommended
   ShaftMaterialType—Type of material used in the shaft of a golf club
   SupportedMediaSize—Specifies the storage media sizes supported
   Add attributes (in release note 2006-09-11):
   In the JP locale, ItemAttributes now returns a new element, IsPreannounce. If the value is present in the response, the item is being announced before being released.
   Update attribute symbol to symbol (in release note 2006-09-11):
   In the JP locale, the symbol that represents a copyright was being returned incorrectly. Now, the copyright symbol is returned correctly in the Feature item attribute, which is returned by the ItemAttributes response group.
   Update attribute ListPrice to ListPrice (in release note 2006-11-14):
   In the DE locale, the ListPrice in ItemAttributes response group returned was incorrect. This problem has been fixed. Most items, however, do not have ListPrice values.

Note: the two attributes “symbol” and “ListPrice” don't change their names, so the description is Update attribute symbol to symbol and Update attribute ListPrice to ListPrice

As shown in FIG. 8, the above change history is input into Code Updater 8024 to help the client to update code on the Eclipse development platform.

For example, if the user didn't update his own client application between 2006-9-10 and 2006-11-15, when he opens his Eclipse editing window after November 15^{th}, the part which need to be adjusted in the application will be shown highlighted. As shown in FIG. 8, it shows in the service client application 8030, the code “ItemAttributes” is shown highlighted. Click on this highlighted part, a window will pop up and link to above mentioned change history record. So the user can easily find the code needs to be updated, for instance, it is necessary to parse and process element “IsPreannounce” in the return message.

In the above sample, change history is listed according to time sequence. The release note on 2006-11-08 didn't involve any change of “ItemAttributes”, so there is no change about the release note on 2006-11-08. In addition, change history can be classified based on change description primitives, such as “ADD”, “UPDATE”, wherein there is no change of “REMOVE” in the above 3 release notes.

It shall be noted that the above-mentioned change history format is just illustrative. As those skilled in the art can understand, the change history recording device in a preferred embodiment can generate a change history record in a tree structure, namely a change history record tree. In this tree, each root node is a web service element, such as method, message and message parameter. Nodes of each level under this root node record changes in relation to this root node element in release notes. The root node is added into the change history record tree when the service element changes the first time, namely when it firstly appears on the current release note. As shown in FIG. 7d, the root nodes are respectively service element A, B and C, under the root nodes, changes in relation to three elements A, B and C in each release note are recorded. Three root nodes, element A, B and C are added into the change history record tree when release note 1 is received. Thus, user can easily and efficiently find out how and when the change happens by referring to this change history record tree. In addition, the most frequently used service elements can be detected, and change history contents are ranked with priority given to said frequently called elements. Therefore, the user can find out the most important changes that most significantly affect the application.

In the above example, the method and device of the present invention is implemented as a plug-in, which is added into the development platform of the web service client application.

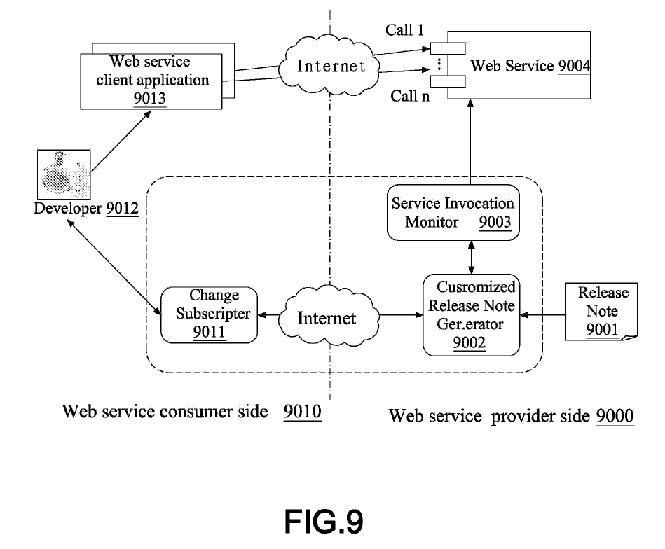

Alternatively, the method and device of the present invention can be implemented in server 2000 at the web service provider side, as shown in FIG. 9. In the system of FIG. 9, Web service 9004 provides a number of methods for the client, web service client application 9013 can call one or more methods provided by the web service via network. The Developer 9012 of the web service client application 9013 can request a customized release note of his interest. The Web Service Provider 9000 can monitor the running status of the called Web service 9004. For instance, calling operations of Web Service 9004 by the user can be monitored by the Service Calling Monitor 9003, therefore the Web Service Provider 9000 detects each service element used by the client. Web Service Provider 9000 can also detect the most frequently used service elements for each user. On the other side, the Web Service Provider 9000 customizes release notes and API update guides for users according to user's request or the monitored running status, and ranked the contents of release notes or API update guides with priority given to calling frequency. For instance, Web Service Provider 9000 provides a Customized Release Note Generator 9002 to receive release notes 9001. In response to the request of Developer User 9012, based on client used elements monitored by the Service Use Monitor 9003, the Customized Release Note Generator 9002 customizes release notes 9001 and sends customized release notes to the change subscriber 9011, which is also at the Web service client side 9010. Thus the Developer User 9012 can obtain customized release notes through change subscriber 9011. The Developer User 9012 can update Web Service client application 9013 based on the customized release notes.

The additional advantages of the embodiment of FIG. 9 are as follows: If the user misses some service change elements, the web service provider can find them out. In addition, related contents of release notes or API update guides can be ranked with priority based on calling frequency of each user. Therefore, each user can find most important changes than most significantly affects the application.

The calling frequency could be for instance, the number of times that a client calls this service element between two release notes being released from web service provider. At the server side, the server can monitor the calling frequency of clients. On the other hand, this could be implemented at the client side, as provided by the client application running environment, such as IBM WebSphere Application Server (WAS) could be adapted to monitor the number of times that a client calls web service for certain period.

As those skilled in the art can understand, alternately, the method and device of the present invention can be implemented in a third party independent of said web service user and provider.

Unless indicated otherwise, the function of the present invention can be run by hardware or software or the combination thereof. However, in a preferred embodiment, unless indicated otherwise, these functions are executed by integrate circuits of one or more processors (such as computer or electronic data processor), based on codes (such as computer program codes). Generally, a method for implementing the embodiment of the present invention could be a part of operating system, a specific application, a program, a module, an object or command sequences. Software of the present invention usually includes computer readable commands, i.e. machine executable commands. In addition, computer programs include parameters and data structures locally or remotely resided in memory. In addition, various kinds of programs can be recognized according to the method that implements the specific embodiment of the present invention. When carrying computer readable commands directed to the present invention, such signal-carrying medium represents an embodiment of the present invention.

Although the description of the present invention refers to the specific embodiments, it should be understood that the present invention is not limited to any embodiment. The appended claims, when interpreted to the widest extent, include all the necessary modifications, equivalents and functions.

1. A change history recording method for recording a change history of web service, including:
a receiving step of receiving a release note containing web service change descriptions;
a transforming step of finding out a change description in relation to customer used elements from the release note;
a history generating step of generating and storing a change history in relation to the customer used elements based on the change description in relation to the customer used elements.

2. The change history recording method of claim 1, wherein the transforming step further includes:
a release note parsing step of parsing the received release note;
a release note translating step of translating the parsed release note into standard change description primitives based on predefined transformation rules;
a customized release note generating step of generating a customized release note on the basis of the translated release note and said customer used elements, wherein the customized release note includes the change description in relation to the customer used elements.

3. The change history recording method of claim 1, wherein the history generating step further includes:
a history creating step of receiving the change description in relation to the customer used elements and generating a new change history in relation to the customer used elements based on a previously created change history.

4. The change history recording method of claim 1, further including:
detecting a frequency of use for the service elements called by user, and ordering contents of the change history according to the frequency of use.

5. The change history recording method of claim 1, further includes:
organizing contents of the change history as a recording tree.

6. A change history recording device for recording a change history of web service, including:
transformation engine, used for receiving a release note containing web service change descriptions, and finding out change descriptions in relation to customer used elements from the release note;
history generating device, used for receiving the change descriptions in relation to the client used elements from the transformation engine, and generating a change history in relation to the customer used elements.

7. The change history recording device of claim 6, wherein the transformation engine further includes:
release note parsing means, used for parsing the received release note;
release note translating means, used for receiving the parsed release note and translating the parsed release note into standard change description primitives based on predefined transformation rules;
customized release note generating means, used for receiving the translated release note and the customer used elements, and generating a customized release note based on the customer used elements, wherein the customized release note includes the change descriptions in relation to the customer used elements.

8. The change history recording device of claim 6, wherein the history generating device further includes:
history repository used for storing a previously generated change history; and
history creating means used for receiving the change descriptions in relation to the customer used elements from the transformation engine, and generating a change history in relation to the customer used elements based on the change history stored in the history repository.

9. The change history recording device of claim 6, wherein the history generating device also detects a frequency of use for service elements called by user, and orders contents of the change history based on the frequency of use.

10. The change history recording device of claim 6, wherein the history generating means organizes contents of the change history content as a recording tree.

11. The change history recording device of claim 6 can be implemented in a client application development platform to help user update his application.

12. The change history recording device of claim 6 can be implemented in a server of the service provider and sends the change history in relation to the customer used elements to users.

13. The change history recording device of claim 6 can be implemented in a third party independent of the web service user and provider and sends the change history in relation to customer used elements to users.

14. A change updating supporter for updating a client application based on one or more release notes, said change updating supporter comprising:
a change history recording device for recording a change history of web service, including:
transformation engine, used for receiving a release note containing web service change descriptions, and finding out change descriptions in relation to customer used elements from the release note;
history generating device, used for receiving the change descriptions in relation to the client used elements from the transformation engine, and generating a change history in relation to the customer used elements;
a release note receiver used for receiving a new release note and inputting it into the change history recording device, said release note including change descriptions of web service;
a code searching means used for searching customer used elements from the client application and inputting them into the change history recording device; and
wherein the change history recording device outputs a change history of the customer used elements.

15. The change updating supporter of claim 14, further comprising:
a code updating assisting means used for receiving the change history in relation to the customer used elements from the change history recording device and presenting it to users.
